(19) United States
(12) Patent Application Publication
(10) Pub. No.: US 2013/0220708 A1
(43) Pub. Date: Aug. 29, 2013

(54) PORTABLE AXLE SCALE SYSTEM USING SMART TERMINAL

(71) Applicants: Hong Kyun KIM, Daejeon (KR); Ki Tae Kim, Daejeon (KR)

(72) Inventors: Hong Kyun KIM, Daejeon (KR); Ki Tae Kim, Daejeon (KR)

(73) Assignees: Hong Kyun Kim, Daejeon (KR); SIMT INC., Daejeon (KR); Ki Tae Kim, Daejeon (KR)

(21) Appl. No.: 13/478,855

(22) Filed: May 23, 2012

(30) Foreign Application Priority Data
Feb. 28, 2012 (KR) 10-2012-0020300

(51) Int. Cl. G01G 23/42

(52) U.S. Cl. 177/3

(57) ABSTRACT

Disclosed is a portable axle scale system using a smart terminal. In the portable axle scale system, a portable smart terminal functions to judge whether or not a vehicle is overloaded based on a result measured by a portable axle scale, and to transmit a variety of information, such as information on the measured vehicle, personal information on a vehicle driver, photographs related to a measurement operation, and positional information on a measurement place, to a server for storage of the information. Then, the smart terminal may transmit the information to a cellular phone or other communication terminals of the vehicle driver to assist the vehicle driver in confirming relevant materials in real-time.

### BACKGROUND OF THE INVENTION

1. Field of the Invention

The present invention relates to a portable axle scale system, and more particularly, to a portable axle scale system using a smart terminal, in which a portable smart terminal can function to judge whether or not a vehicle is overloaded based on a result measured by a portable axle scale, and to transmit a variety of information, such as information on the measured vehicle, personal information on a vehicle driver, photographs related to a measurement operation, and positional information on a measurement place, to a server for storage of the information, and thereafter to transmit the information to a cellular phone or other communication terminals of the vehicle driver to assist the vehicle driver in confirming relevant materials in real-time.

2. Description of the Related Art

Upon road traffic of an overloaded vehicle, an excessive load applied to the road may accelerate generation of cracks in the road and cause plastic deformation thereof, significantly shortening the lifespan of the road. Moreover, a risk for traffic accidents may be increased due to damage to the road, and enormous time and costs may be consumed for the repair of the damaged road.

In particular, overloading of large trucks has been pointed out as a main reason behind damage to roads. In the article 4(1) of the Regulation enacted in the Ministry of Construction and Transportation in Korea, the regulatory criterion is prescribed as “A vehicle, the weight of which does not exceed an axle load of 10 tons or a total weight of 40 tons, is permitted” (cf, the axle load and the total weight of the vehicle exceeding the above criteria by ten percent may be permitted in consideration of the kinds of meters, measurement errors, and the like).

Typically, the effects of the traffic of overloaded trucks on paved roads are known as follows: an axle load of 10 tons causes damage to the road equal to the traffic of 70,000 cars; an axle load of 11 tons causes damage to the road equal to the traffic of 110,000 cars; and an axle load of 15 tons causes damage to the road equal to the traffic of 390,000 cars.

Also, in the article 39 of the Road Traffic Act in Korea, it is prescribed that “Motorists of all types of vehicles must not to drive the vehicle in a state in which passengers or freight are loaded beyond a traveling safety criterion prescribed by the presidential decree with respect to the number of passengers, the loading weight, and the loading capacity”. Thus, a crackdown has been conducted on vehicles that violate the legal maximum loading weight. Although the legal maximum loading weight differs from the weight criterion of an overloaded vehicle, a vehicle that that violates the legal maximum loading weight is a subject of control in terms of eliminating all hazards and obstacles on the road as well as damage to the road. Therefore, it is understood that even the vehicle that violates the legal maximum loading weight may be similar to an overloaded vehicle.

In general, apparatuses for identifying an overloaded vehicle are basically classified into an apparatus that measures the weight of a vehicle in a stationary state thereof and an apparatus that measures the weight of a vehicle during traveling. A typical overloaded vehicle identifying apparatus, which is installed on an expressway ramp, is designed to determine whether or not a vehicle that is traveling at a speed of 30 kph or less is overloaded. On the other hand, a portable overloaded vehicle identifying apparatus is generally used on the national highway to measure the weight of a vehicle in a stationary state thereof.

Also, in the Act enacted since 2009, trucks on construction sites are obligatory to have an axle load measurement system for measuring the weight of freight, and individual local governments have oversight of the Act.

In the case of the portable overloaded vehicle identifying apparatus, instead of employing a typical method, proposed by the Korean Expressway Corporation, for measuring the weight of a truck in real time during traveling, a plurality of sensing pads, which corresponds to the number of axles of a truck, has been used to simultaneously measure loads of the respective axles in a stationary state of the truck, or a set of portable sensing pads has been used to measure a load of each axle during movement of the truck.

Additionally, through use of the sensing pads for measuring an axle load and a dedicated controller, it has been judged whether or not a vehicle is overloaded, and measurement evidence, i.e. a certificate output from a printer, which is connected to the dedicated controller or a computer, has been submitted to a vehicle driver. The dedicated controller serves to store relevant materials, such as load data of each axle and information on a measured vehicle, such as, for example, a truck.

However, the above described measuring method may problematically cause loss of data and have a weak point in terms of security because changing information is possible, thus having a difficulty in storage and management of data as well as a lack of enforceability.

For this reason, there is a demand for an axle scale system, which may eliminate a need for a conventional dedicated controller, may prevent unnecessary time and cost consumption due to publication of a paper certificate, may solve problems in that one local government is inadequate to manage portable axle scales installed on a number of locations in real time, and may improve security and system reliability as compared to conventional axle scale systems.

### SUMMARY OF THE INVENTION

Therefore, the present invention has been made in view of the above problems, and it is an object of the present invention to provide a portable axle scale system using a smart terminal, in which a portable smart terminal can function to judge whether or not a vehicle is overloaded based on a result measured by a portable axle scale, and to generate a barcode containing data on site photographs, positional data, and the measured result to thereby transmit the data to an operating server and a cellular phone of a vehicle driver in real time, whereby data security and convenience in management can be accomplished.

In accordance with an aspect of the present invention, the above and other objects can be accomplished by the provision of a portable axle scale system for performing an axle weight measurement operation using a smart terminal, the system including at least one portable sensing pad, wherein the portable sensing pad includes a weight sensor that measures an axle weight of a vehicle to output a weight signal, a first communicator in the form of a wireless communication module, a first controller that controls the weight sensor in response to a measurement request signal received through the first communicator and includes a weight information generator to process the weight signal and generate weight information, the first controller transmitting the weight information through the first communicator, a power controller that supplies power to the first controller, and a waterproof body that is provided at an upper portion thereof with the power controller and is configured to accommodate the first communicator and the first controller, the weight sensor being mounted in the center of the body, and a smart terminal, wherein the smart terminal includes a second communicator that performs reception and transmission of signals and data with the first communicator, a third communicator that is connected to a designated wired or wireless communication network for reception and transmission of signals and data, a measurement requester that transmits the measurement request signal to the first controller through the second communicator, an input unit that receives information on the measured vehicle and a vehicle driver, time and location information on the date and place of a measurement operation, and signature of the vehicle driver from a human manager, a camera that takes a photograph of the measured vehicle, a measured data generator that collects the weight information transmitted from the first controller, the information on the measured vehicle, the time and location information, and the signature input from the input unit, and the photograph captured by the camera to generate measured data; a display unit that outputs an image signal to the human manager, and a second controller that controls the second communicator, the third communicator, the measurement requester, the input unit, the camera, and the measured data generator, converts signals and data into image signals to output the image signals via the display unit, and transmits the measured data through the third communicator.

The smart terminal may further include a position meter that acquires positional information on a place where a weight measurement is performed, and a barcode generator that generates a barcode containing the measured data, the measured data generator may add the positional information input from the position meter to the measured data, and the second controller may control the position meter and the barcode generator to transmit the barcode through the third communicator.

The portable axle scale system may further include an operating server, and the operating server may include a fourth communicator that performs reception and transmission of data and signals with the third communicator and is connectable to an external communication network, a database that stores the measured data received from the fourth communicator, a certification data generator that generates certification data for confirmation and storage by the driver of the measured vehicle by processing the barcode and the measured data received from the fourth communicator, and a third controller that controls the fourth communicator, the database, and the certified data generator, and transmits the generated certified data to a cellular phone of the driver of the measured vehicle through the fourth communicator.

The portable sensing pad may further include a temperature and humidity meter that measures the temperature and humidity of a place where the body is installed to generate temperature and humidity information, and a memory in which verification/correction information including a verification/correction date received from the weight sensor, a zero point setting value and an offset value, the first controller may further include a verification/correction information transmitter that reads verification/correction information from the memory and transmits the information through the first communicator along with the temperature and humidity information, and the second controller may include a verification/correction information processor that outputs the verification/correction information via the display unit, or transmits the verification/correction information to an operating server through the third communicator.

The power controller may include a magnetic switch installed in an upper region of the body, the magnetic switch being turned on or off by external magnetic force, and a magnetic substance used to operate the magnetic switch at the outside of the body.

The power controller may include a battery and a power meter to measure remaining power of the battery, the first controller may transmit a signal informing the remaining power measured by the power meter through the first communicator, and the second controller may include a battery information processor to output the remaining power of the battery via the display unit.

The body may include stoppers protruding upward respectively from front and rear sides of the body in a vehicle movement direction, and dummy pads provided respectively at the front and rear sides of the body to extend from the ground to the top of the stoppers.

The at least one portable sensing pad may include a plurality of portable sensing pads, and the portable axle scale system may further include a repeater, which is connected to the first communicators of the plurality of portable sensing pads to collect the weight information from the respective portable sensing pads and transmit the collected weight information to the second communicator of the smart terminal.

The camera may read a photographed license plate of the vehicle such that the read result is included in the information on the measured data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual view showing a version in which an axle weight is measured using a smart terminal according to the present invention;

FIG. 2 is a conceptual view showing a portable axle scale system using a smart terminal according to the present invention;

FIG. 3 is a block diagram showing a connection relationship of constituent elements included in a portable axle scale system using a smart terminal according to a preferred embodiment of the present invention;

FIG. 4 is an exemplary view showing visible data provided by a smart terminal and an operating server according to the present invention;

FIG. 5 is a block diagram showing a connection relationship of constituent elements included in a portable axle scale system using a smart terminal according to another embodiment of the present invention;

FIG. 6 is a perspective view showing a power controller including a magnetic switch and a magnetic substance according to the present invention;

FIG. 7 is a perspective view showing the appearance of a portable sensing pad provided with stoppers and dummy pads according to the present invention; and

FIG. 8 is a conceptual view showing a version in which weight signals from a plurality of portable sensing pads are transmitted to a smart terminal by way of a repeater according to the present invention.

### DETAILED DESCRIPTION OF THE INVENTION

Hereinafter, a configuration of a portable axle scale system using a smart terminal according to the present invention will be described in more detail with reference to the accompanying drawings.

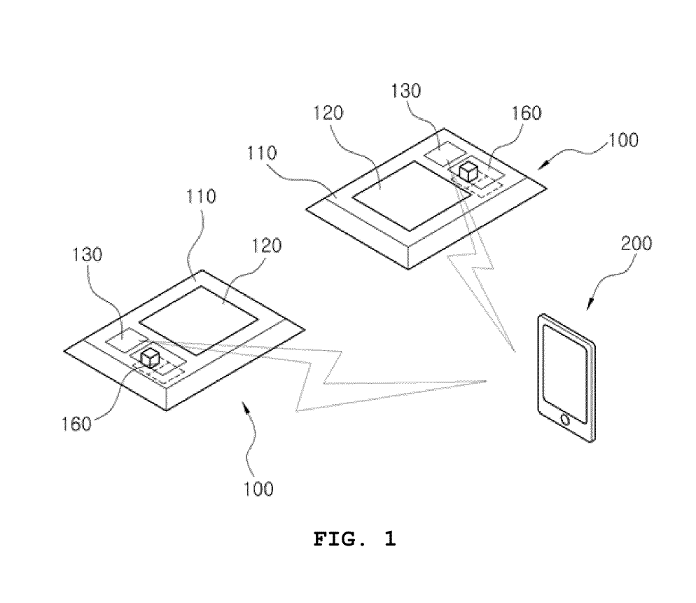

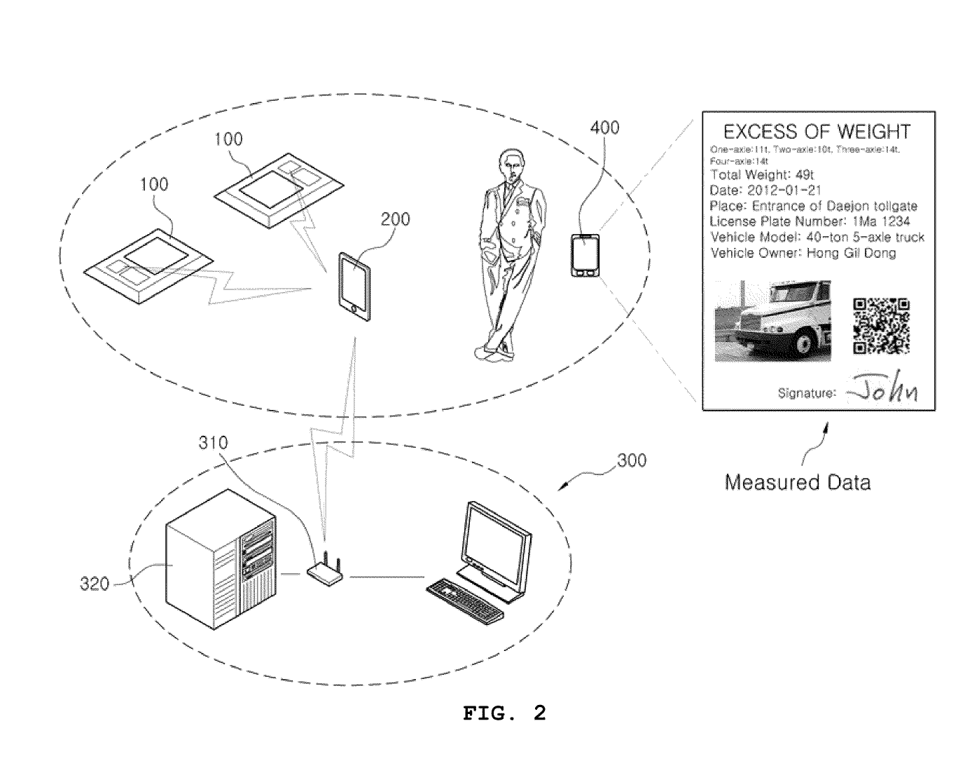

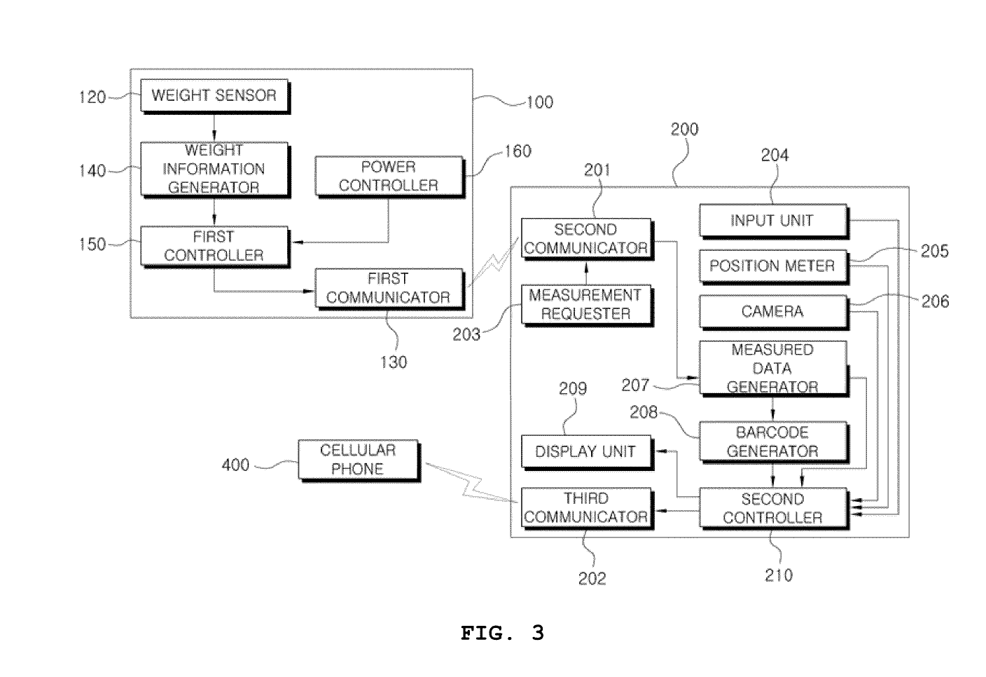

FIG. 1 is a conceptual view showing a version in which an axle weight is measured using a smart terminal according to the present invention, FIG. 2 is a conceptual view showing a portable axle scale system using a smart terminal according to the present invention, and FIG. 3 is a block diagram showing a connection relationship of constituent elements included in a portable axle scale system using a smart terminal according to a preferred embodiment of the present invention.

As shown in FIGS. 1 and 2, the portable axle scale system using a smart terminal according to the present invention includes a plurality of portable sensing pads 100 and a smart terminal 200. The portable sensing pads 100 are installed at a measurement place, and may serve to measure the weight of a single axle of a vehicle, or may serve to simultaneously measure the weights of two to five axles. The smart terminal 200 is provided with a dedicated application for converting signals, received from the portable sensing pads 100 through wireless communication, such as a Bluetooth, Wi-Fi or the like, into digital values to process the measured result.

A conventional portable axle scale system is constituted by sensing pads that occupy a relatively large volume, and a dedicated terminal device for controlling the sensing pads, thus having poor portability. Moreover, due to the fact that verification and other procedures are performed in off-line via document works, it is impossible for the conventional portable axle scale system to perform transmission of evidentiary photographs, generation of a related barcode, real-time processing, storage and management of data, and the like. In addition, system price may be a heavy burden if a purchaser is an individual business.

However, in the present invention, since reception and transmission of signals and data are accomplished through wireless communication between the light-weight portable sensing pads 100 and the portable smart terminal 200, the portable axle scale system has excellent portability. Further, the portable axle scale system can be built at low cost through the use of the smart terminal 200 having a high penetration rate. Furthermore, in case of using a management operating server 300, effective management of a plurality of portable axle scale systems distributed at several locations can be accomplished.

The portable sensing pads 100 are temporarily installed at a designated location to measure an axle weight of a truck that is an object to be measured. Each of the portable sensing pads 100 includes a body 110, a first communicator 130, a weight sensor 120, a first controller 150, and a power controller 160.

The body 110 is an outer case of the portable sensing pad 100 and is formed of a sufficiently rigid material to overcome a vehicle load, such as a metal, reinforced plastic, and the like. The first communicator 130 and the first controller 150 are accommodated in the body 110. Consideration of the fact that the body 110 is installed at an outdoor location where vehicle traffic is present, the body 110 has a water-proof function at inner and outer sides thereof to prevent electric and electronic devices accommodated therein from being damaged due to invasion of moisture, and the like.

The weight sensor 120 is mounted in a central region of the body 110 or at a central bottom position of the body 110. The weight sensor 120 serves to measure an axle weight of the vehicle that passes over the weight sensor 120 to output a weight signal. In this case, although the weight sensor 120 may be selected from among a variety of sensors that convert an applied load into a weight signal to output the weight signal, in the present invention, a sensor or load cell for converting applied pressure into a voltage value to output the voltage value may be used. In this case, the weight sensor 120 must be frequently verified and corrected because the output voltage value may be erroneous due to the used period of the weight sensor 120 and the temperature or humidity of surroundings, and the like.

The first communicator 130 serves to perform reception and transmission of signals and data with the smart terminal 200. The first communicator 130 may be generally a Bluetooth or Wi-Fi communication module, which adopts the same short-range wireless communication as that applied to the smart terminal 200. In the present invention, it is preferable to use a Wi-Fi communication module that can communicate with two or more portable sensing pads 100 and ensure easier use by a human manager.

The first controller 150 serves to control the first communicator 130 and the weight sensor 120. In particular, the first controller 150 operates the weight sensor 120 in response to a measurement request signal received through the first communicator 130 to perform a weight measurement operation. The first controller 150 includes a weight information generator 140 to generate weight information by processing the weight signal output from the weight sensor 120. The weight information generator 140 generates weight information by converting the analogue weight signal containing a voltage value into a digital signal, for the sake of efficient and rapid processing of the weight signal. In this case, it is well known to those skilled in the art that the weight information generator 140 includes a filter circuit to remove noise contained in the weight signal and an amplifier circuit to amplify the slight weight signal up to an appropriate level. Thus, a detailed description thereof will be omitted herein.

The first controller 150 transmits the generated weight information to the smart terminal 200 through the first communicator 130.

The power controller 160 is provided with an external power source or a built-in battery to supply power to the first controller 150. Generally, it is preferable to supply power using a rechargeable or disposable battery, rather than supplying power using an external power source that is connected using a power cable, in consideration of the fact that the body 110 is mounted outdoors.

The smart terminal 200 is a concept including a conventional personal smart phone or smart pad. The smart terminal 200 may perform communication with the operating server 300 through a wireless communication network, such as a CDMA 3G or 4G network, Wi-Fi network or the like, or through a wired communication network. Alternatively, the smart terminal 200 may construct a network with the operating server 300 that will be described hereinafter through the Internet or Intranet.

In the present invention, the smart terminal 200 includes a second communicator 201, a third communicator 202, a measurement requester 203, an input unit 204, a position meter 205, a camera 206, a measured data generator 207, a barcode generator 208, a display unit 209, and a second controller 210.

Considering the aforementioned elements in sequence, first, the second communicator 201 is a communication module that performs reception and transmission of signals and data with the first communicator 130. More particularly, the second communicator 201 includes a Wi-Fi communication module in the same manner as the first communicator 130.

The third communicator 202 serves to perform reception and transmission of signals and data with a cellular phone 400 of a vehicle driver. More particularly, the third communicator 202 may perform reception and transmission of signals and data through a cellular phone mobile communication network, such as a CDMA 3G or 4G network. Of course, although the third communicator 202 may be configured to receive and transmit data through a variety of communication networks as well as a commercially available cellular phone mobile communication network, it is preferable to use the commercially available cellular phone mobile communication network that is convenient in use without installation of a separate communication network, in consideration of the fact that the portable sensing pad 100 is generally mounted at an out of the way place, such as an expressway ramp, and at a place where installation of a wired communication network is troublesome.

The measurement requester 203 serves to assist a human manager who has completely prepared measurement of an axle weight in transmitting a measurement request signal to the first controller 150 of the portable sensing pad 100. If the human manager operates the measurement requester 203, a measurement request signal is transmitted to the first controller 150 through the second communicator 201, and the first controller 150 controls the weight sensor 120 to perform a weight measurement operation upon receiving the transmitted measurement request signal.

The input unit 204 is a keypad or touch pad of the smart terminal 200. The input unit 204 receives, from the human manager, information about the measured vehicle including the model of the vehicle, the license plate number, and the name and phone number of the vehicle driver, time and location information including an axle weight measurement date and time and a measurement place, and the signature of the vehicle driver.

The position meter 205 is a GPS receiver mounted in the smart terminal 200 and serves to acquire positional information on a place where the weight measurement is performed, and to mark the place on a map. Although the human manager primarily inputs information on a measurement position using the input unit 204, the smart terminal 200 may secondarily receive information on the measurement position through the position meter 205 for verification of the information. Through use of the position meter 205, the procedure of inputting the information on the measurement position using the input unit 204 may be omitted.

The camera 206 is a small camera mounted in the smart terminal 200 to photograph a vehicle, the weight of which is being measured, so as to retain the photograph as evidentiary material of the measurement operation.

In this case, the camera 206 may be configured to read a photographed license plate of the vehicle so as to recognize the license plate number and allow the recognized information to be included in the information on the measured vehicle. That is, even if the license plate number is not separately input via the input unit 204, when photographing the license plate of the vehicle via the camera 206, the license plate number can be automatically recognized and be included in the information on the measured vehicle. This may be realized via an Optical Character Recognition (OCR) program or a character recognition program using pattern matching, structure analysis, and the like, which may ensure more rapid and convenient operation.

The measured data generator 207 generates measured data by collecting the weight information transmitted through the first controller 150, the information on the measured vehicle, time and location information, and signature input from the input unit 204, positional information input from the position meter 205, and photographs captured by the camera 206. In this case, an operation of calculating an axle weight using the weight information is simultaneously performed. Generally, since the weight information includes an axle weight, and there are a variety of methods for calculating the axle weight according to the kinds of sensors, the weight signal can be changed into a weight value in kilograms using an appropriate method.

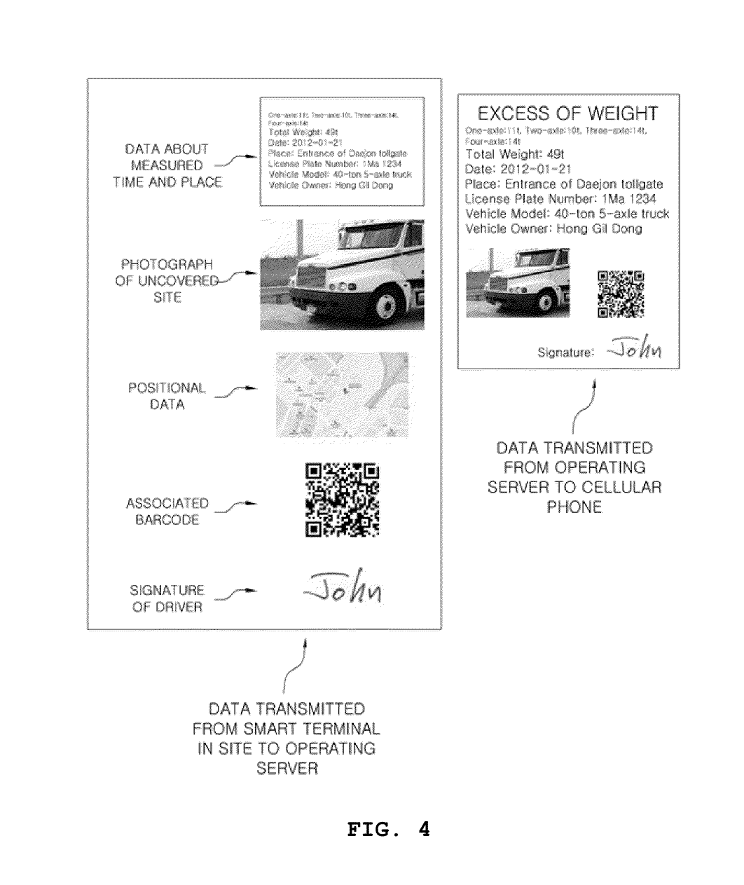

The measured data includes contents of documents that are published after a conventional axle weight measurement operation, and also includes results of judging whether or not a vehicle is overloaded based on the measured axle weight. FIG. 4 is a view showing one example of visible data provided by the smart terminal and the operating server.

The barcode generator 208 serves to generate a Quick Response (QR) code containing information on the measured data. The QR code is a 2-dimentional barcode in the form of a matrix, and the maximum 7,089 numbers, the maximum 4,296 characters, and the maximum 1,817 Chinese characters may be recorded in the QR code. In this way, the generated barcode may contain all of the measured data including, for example, Internet addresses (Uniform Resource Locators (URLs)), photographs and moving images, map information, and card information. The vehicle driver or the human manager may rapidly confirm the measured data by scanning the generated barcode.

The display unit 209 serves to output image signals that the human manager can visibly confirm. The display unit 209 corresponds to a screen of the smart terminal 200. The human manager may confirm the information on the measured vehicle input via the input unit 204, time and location information, signature and positional information, photographs, measured data, generated barcode, and the like.

The second controller 210 serves as a Central Processing Unit (CPU) of the smart terminal 200, and controls the second communicator 201, the third communicator 202, the measurement requester 203, the input unit 204, the position meter 205, the camera 206, the measured data generator 207, the barcode generator 208, and the display unit 209. The second controller 210 serves to convert input data into image signals and to output the image signals via the display unit 209 so as to assist the human manager in confirming the data. The second controller 210 also serves to transmit the measured data and the generated barcode to the operating server 300 or the cellular phone 400 of the vehicle driver through the third communicator 202.

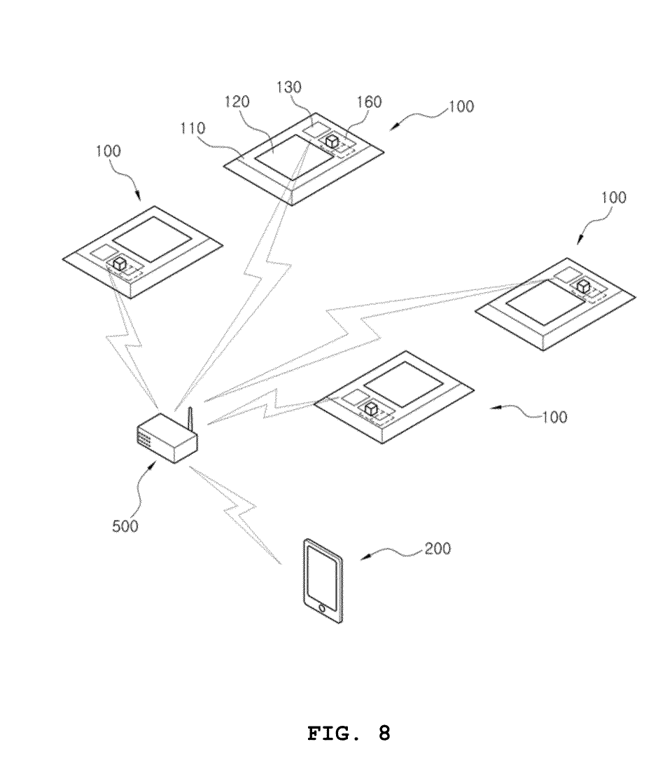

FIG. 8 is a conceptual view showing a version in which weight signals from a plurality of portable sensing pads are transmitted to a smart terminal by way of a repeater according to the present invention. As shown in FIG. 8, the minimum two or more portable sensing pads 100 are required to perform a general axle load measurement operation. As occasion demands, four or more portable sensing pads may be used to simultaneously measure the weights of all axles.

In this case, a typical smart terminal using a Bluetooth and Wi-Fi communication module has a problem in that it cannot simultaneously receive weight information transmitted from a plurality of portable sensing pads. To solve this problem, it is preferable that a repeater 500 be provided to collect weight information transmitted from the first communicators 130 of the plurality of portable sensing pads 100 and to transmit the collected information to the second communicator 201 of the smart terminal 200.

Also, since the repeater 500 and the plurality of portable sensing pads 100 may have difficulty in receiving and transmitting weight information through Bluetooth or Wi-Fi communication, it is preferable to use ZigBee communication. That is, transmission of the weight information from the first communicators 130 to the repeater 500 is realized through Zigbee communication, and transmission of the collected information from the repeater 500 to the second communicator 201 is realized through Wi-Fi or Bluetooth communication.

Also, in the case in which the first communicator 130 takes the form of a ZigBee communication module, transmission of signals and data between the plurality of portable sensing pads 100 may be realized.

As shown in FIGS. 1 and 3, an axle weight measurement operation may be performed via an independent system consisting of the portable sensing pads 100 and the smart terminal 200, and the measured result may be directly transmitted to the vehicle driver. However, in the case in which the plurality of portable sensing pads 100 and the smart terminals 200 to be managed are provided such that axle weight measurement operations are performed sporadically at several locations, it is necessary to provide the operating server 300 for real-time management of results of the axle weight measurement operations.

Providing the operating server 300 is also preferable because the real-time management of results of the axle weight measurement operations enables accurate and rapid work and can prevent traffic of an overloaded vehicle.

Moreover, by systematically managing the measured data generated at several locations where the portable sensing pads 100 are installed, the operating server 300 may be a realistic alternative for reducing workload because a separate memory conversion operation and other subsequent operations related to the exposure of overloaded vehicles are not necessary.

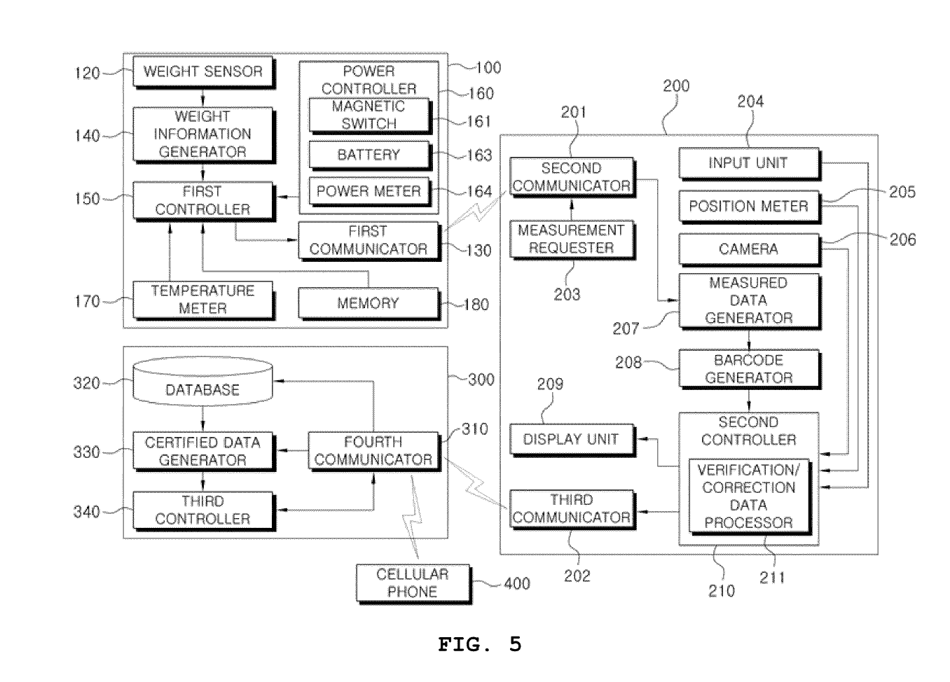

FIG. 5 is a block diagram showing a connection relationship of constituent elements included in a portable axle scale system using a smart terminal according to another embodiment of the present invention. In the present embodiment, the operating server 300 that serves to manage the portable sensing pads 100 located at several locations and the smart terminal 200 and a configuration for transmitting information on the weight of each axle, verification/correction information of the weight sensor 120, and power information of the power controller 160 to the smart terminal 200 are additionally provided.

First, the operating server 300 serves to manage the measured data from the portable sensing pads 100 installed at several places and the smart terminal 200 as well as an overloaded vehicle detection operation on the whole. The operating server 300 includes a fourth communicator 310, a database 320, a certification data generator 330, and a third controller 340.

The fourth communicator 310 may serve to perform reception and transmission of signals and data with the third communicator 202 using a commercially available cellular phone mobile communication network, or may serve to transmit data to the cellular phone 400.

The database 320 serves to store the measured data transmitted from the smart terminal 200 to the fourth communicator 310. All the measured data obtained from the axle weight measurement operations that are performed at several places are collected and stored in the database 320, which assists a corresponding government service and road management organization in easily controlling and managing the measured data via the operating server 300.

The certification data generator 330 serves to generate certification data required to prove the results of the axle weight measurement operation to the vehicle driver. To this end, the certification data generator 330 processes the measured data received from the fourth communicator 310 to generate certification data, such as information to be transmitted from the operating server 300 to the cellular phone 400 as shown in FIG. 4, such that the driver of the measured vehicle confirms and stores the certification data.

The third controller 340 serves as a CPU of the operating server 300. The third generator 340 functions to control the fourth communicator 310, the database 320, and the certification data generator 300 and to transmit the generated certification data to the cellular phone of the driver of the measured vehicle through the fourth communicator 310.

In this case, the transmitted certification data makes it unnecessary to prepare or store relevant evidentiary materials in the form of paper documents differently from the related art. However, if necessary, the certification data may be transmitted by e-mail, fax, or post to the driver or the corresponding public office and organization. Such an innovative work improvement may be very helpful to achieve convenience and accuracy in the measurement of an axle weight and the regulation of an overloaded vehicle and to reduce time and costs.

The portable sensing pad 100 may further include a temperature/humidity meter 170 and a memory 180. The temperature/humidity meter 170 includes a thermometer and a hygrometer in the form of digital devices. The temperature/humidity meter 170 serves to measure the temperature and humidity of a place where the portable sensing pad 100 is installed, thereby generating temperature and humidity information.

The memory 180 serves to store verification/correction information, including a final verification/correction date received from the weight sensor 120, zero point setting value and offset value required for a verification/correction operation. After completion of a verification/correction operation, a value stored in the memory 180 is updated to a final value.

The first controller 150 may further include a verification/correction information transmitter 151 to read the verification/correction information stored in the memory 180 and transmit the information through the first communicator 130. This assists the human manager in confirming the verification/correction operation of the weight sensor 120, and may be helpful to recognize a current state of the weight sensor 120 and to establish a later verification/correction plan.

The second controller 210 may further include a verification/correction information processor 211 to output the verification/correction information transmitted from the verification/correction information transmitter 151 via the display unit 209, or to transmit the verification/correction information to the operating server 300 through the third communicator 202. In this way, the second controller 210 assists the human manger in confirming the verification/correction information, and similarly assists the corresponding public office or organization in confirming the verification/correction information via the operating server 300.

In this case, the power controller 160 may further include a battery 163 and a power meter 164 to measure remaining power of the battery 163. Thus, the power controller 160 functions to constantly measure the remaining power of the battery 163, and the first controller 150 functions to transmit a remaining power value measured by the power meter 164 to the smart terminal 200 through the first communicator 130. The second controller 210 may further include a battery information processor 211 to output information on the remaining battery to the display unit 209, thereby allowing the human manager to easily confirm the remaining power of the portable sensing pad 100. This may prevent a glitch in an axle weight measurement operation due to sudden power loss.

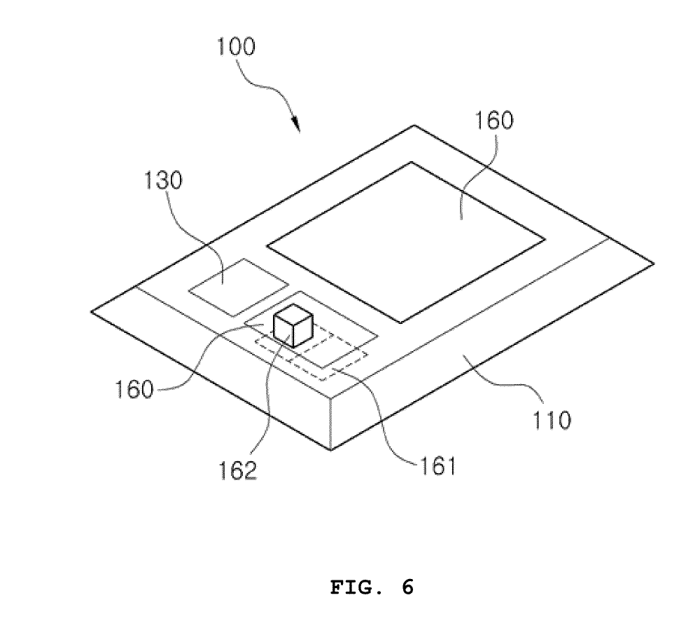

FIG. 6 is a perspective view showing the power controller including a magnetic switch and a magnetic substance according to the present invention. In FIG. 6, the outer appearance of the body 110 that requires a complete waterproof treatment to protect internal components from moisture is shown.

The body 110 is formed of plastics or other synthetic materials that transmit magnetic force. The power controller 160 includes a magnetic switch 161 installed in the body 110 and a magnetic substance 162 used to operate the magnetic switch 161 at the outside of the body 110.

More particularly, the magnetic switch 161 is installed at an inner upper position of the body 110 such that an on/off operation thereof is controlled by external magnetic force. In the present invention, the magnetic switch 161 is turned on when magnetic force is applied to the magnetic switch 161, and is turned off when the magnetic force is not applied.

The magnetic substance 162 is a strongly magnetic element sufficient to transmit magnetic force to the magnetic switch 161 through the body 110. This ensures safe operation of the power controller 160 because the body 110 is watertight and has no electrically exposed portion.

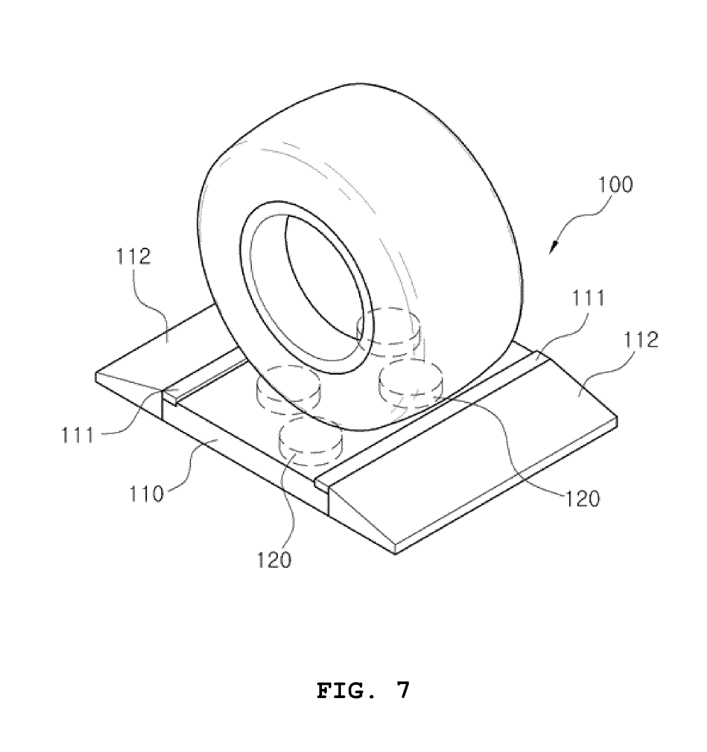

FIG. 7 is a perspective view showing the appearance of the portable sensing pad provided with stoppers and dummy pads according to the present invention. The body 110 preferably further includes stoppers 111 and dummy pads 112.

The stoppers 111 assist a wheel of the measured vehicle located on the body 110 in being positioned at the center of the body 110 where the weight sensor 120 is mounted, for more accurate weight measurement. The stoppers 111 protrude upward from the body 110 at front and rear positions in a movement direction of the vehicle. More specifically, the wheel of the vehicle is located in an indented portion between both stoppers 111. In this case, the height of the stoppers 111 is preferably determined to assist the vehicle driver in detecting that the vehicle passes over the stoppers 111. In this way, the driver can appreciate that the wheel of the vehicle is seated between the stoppers 111.

To alleviate shock caused when the wheel of the vehicle passes over the stoppers 111 from the ground on which the portable sensing pad 100 is installed, the dummy pads 112 are provided. The dummy pads 112 are formed at front and rear sides of the body 110 to define a slope or step from the ground to the top of the stoppers 111. If the dummy pad 112 defines the slope, the inclination angle is generally in a range of 20˜30 degrees. In this way, the wheel of the vehicle first is positioned on the front dummy pad to thereby be introduced between the stoppers 111, and after completion of measurement, goes down along the rear dummy pad.

As is apparent from the above description, in a portable axle scale system according to the present invention, a portable smart terminal can be used to judge whether or not a vehicle is overloaded based on a result measured by a plurality of portable sensing pads that measures an axle weight, and to generate a barcode, in which photographs related to measurement works, data about a measurement time and position, and the measured result, are recorded, to thereby transmit the barcode to a vehicle driver so as to assist the vehicle driver in confirming evidentiary materials related to overloading in real time. This has the effect of considerably reducing time and cost as compared to a conventional method using paper documents.

Further, the real-time transmission and confirmation of the measured result makes it impossible to change security data related to overloading and data about the measured result, resulting in enhanced security. Also, a single operating server can be used to manage portable axle scales installed at several places in real time, which enables effective management of the axle scale system.

Furthermore, according to the present invention, it is possible to prevent an illegal measurement and to effectively crack down overloaded vehicles, which has the effect of preventing damage to roads and ensuring more economical freight transportation owing to observance of an appropriate loading weight.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable axle scale system for performing an axle weight measurement operation using a smart terminal, the system comprising:
at least one portable sensing pad, wherein the portable sensing pad includes: a weight sensor that measures an axle weight of a vehicle to output a weight signal; a first communicator in the form of a wireless communication module; a first controller that controls the weight sensor in response to a measurement request signal received through the first communicator and includes a weight information generator to process the weight signal and generate weight information, the first controller transmitting the weight information through the first communicator; a power controller that supplies power to the first controller; and a waterproof body that is provided at an upper portion thereof with the power controller and is configured to accommodate the first communicator and the first controller, the weight sensor being mounted in the center of the body; and
a smart terminal, wherein the smart terminal includes: a second communicator that performs reception and transmission of signals and data with the first communicator; a third communicator that is connected to a designated wired or wireless communication network for reception and transmission of signals and data; a measurement requester that transmits the measurement request signal to the first controller through the second communicator; an input unit that receives information on the measured vehicle and a vehicle driver, time and location information on the date and place of a measurement operation, and signature of the vehicle driver from a human manager; a camera that takes a photograph of the measured vehicle; a measured data generator that collects the weight information transmitted from the first controller, the information on the measured vehicle, the time and location information, and the signature input from the input unit, and the photograph captured by the camera to generate measured data; a display unit that outputs an image signal to the human manager; and a second controller that controls the second communicator, the third communicator, the measurement requester, the input unit, the camera, and the measured data generator, converts signals and data into image signals to output the image signals via the display unit, and transmits the measured data through the third communicator.

2. The portable axle scale system according to claim 1,
wherein the smart terminal further includes a position meter that acquires positional information on a place where a weight measurement is performed, and a barcode generator that generates a barcode containing the measured data,
wherein the measured data generator adds the positional information input from the position meter to the measured data, and
wherein the second controller controls the position meter and the barcode generator to transmit the barcode through the third communicator.

3. The portable axle scale system according to claim 1, further comprising an operating server,
wherein the operating server includes: a fourth communicator that performs reception and transmission of data and signals with the third communicator and is connectable to an external communication network; a database that stores the measured data received from the fourth communicator; a certification data generator that generates certification data for confirmation and storage by the driver of the measured vehicle by processing the barcode and the measured data received from the fourth communicator; and a third controller that controls the fourth communicator, the database, and the certified data generator, and transmits the generated certified data to a cellular phone of the driver of the measured vehicle through the fourth communicator.

4. The portable axle scale system according to claim 1,
wherein the portable sensing pad further includes a temperature and humidity meter that measures the temperature and humidity of a place where the body is installed to generate temperature and humidity information, and a memory in which verification/correction information including a verification/correction date received from the weight sensor, a zero point setting value and an offset value,
wherein the first controller further includes a verification/correction information transmitter that reads verification/correction information from the memory and transmits the information through the first communicator along with the temperature and humidity information, and
wherein the second controller includes a verification/correction information processor that outputs the verification/correction information via the display unit, or transmits the verification/correction information to an operating server through the third communicator.

5. The portable axle scale system according to claim 1, wherein the power controller includes:
a magnetic switch installed in an upper region of the body, the magnetic switch being turned on or off by external magnetic force; and
a magnetic substance used to operate the magnetic switch at the outside of the body.

6. The portable axle scale system according to claim 1,
wherein the power controller includes a battery and a power meter to measure remaining power of the battery,
wherein the first controller transmits a signal informing the remaining power measured by the power meter through the first communicator, and
wherein the second controller includes a battery information processor to output the remaining power of the battery via the display unit.

7. The portable axle scale system according to claim 1, wherein the body includes:
stoppers protruding upward respectively from front and rear sides of the body in a vehicle movement direction; and
dummy pads provided respectively at the front and rear sides of the body to extend from the ground to the top of the stoppers.

8. The portable axle scale system according to claim 1,
wherein the at least one portable sensing pad includes a plurality of portable sensing pads, and
wherein the portable axle scale system further comprises a repeater, which is connected to the first communicators of the plurality of portable sensing pads to collect the weight information from the respective portable sensing pads and transmit the collected weight information to the second communicator of the smart terminal.

9. The portable axle scale system according to claim 1, wherein the camera reads a photographed license plate of the vehicle such that the read result is included in the information on the measured data.
